(19) United States
(12) Patent Application Publication
(10) Pub. No.: US 2021/0224416 A1
(43) Pub. Date: Jul. 22, 2021

(54) CRYPTOGRAPHIC KEY MANAGEMENT

(71) Applicant: IXUP IP Pty Ltd, Sydney, New South Wales (AU)

(72) Inventors: Dean JOSCELYNE, Sydney (AU); Paul COE, Sydney (AU)

(73) Assignee: IXUP IP Pty Ltd, Sydney, New South Wales (AU)

(21) Appl. No.: 17/055,477

(22) PCT Filed: May 7, 2019
(86) PCT No.: PCT/AU2019/050417

§ 371 Date: Nov. 13, 2020

(30) Foreign Application Priority Data
May 15, 2018 (AU) 2018901684

(51) Int. Cl. G06F 21/62; G06F 21/60; H04L 9/08; H04L 29/06

(52) U.S. Cl. CPC G06F 21/6245; G06F 21/602; G06F 2221/2141; H04L 63/083; H04L 9/0819; H04L 9/0894

(57) ABSTRACT

This disclosure relates to a system for managing access to compliant collaboration data. A collaboration data store stores collaboration data that is encrypted with a collaboration master key associated with a collaboration between one or more organisations. The collaboration master key is shared by the one or more organisations associated with the collaboration. A key store stores the collaboration master key associated with the collaboration. A governance module determines the collaboration data is compliant with a set of compliance rules and based on the determination selectively cause access to be granted to the collaboration master key. Access by the same entity is prevented to two or more of the collaboration data store, key store and governance module.

### CROSS-REFERENCE TO RELATED APPLICATIONS

The present application claims priority from Australian Provisional patent Application No 2017903418 filed on 24 Aug. 2017, the contents of which are incorporated herein by reference in their entirety.

### TECHNICAL FIELD

The present invention relates to the field of managing access to collaboration data. In particular to a method, system and software for managing access to collaboration data on the basis of compliance with defined compliance rules.

### BACKGROUND

The following disclosure relates to collaboration and collaboration data. A collaboration is any activity between two or more organisations that may result in sharing collaboration data. In this sense, collaboration in the context of confidential data or personally identifiable data means that the data itself remains protected from other parties while aggregated data or insights into the data are made available to other parties. Such collaboration data is data that can be shared between two or more organisations.

In general, compliance means conforming to a rule, such as a specification, policy, standard or law. There are many forms of compliance. For example regulatory compliance describes the goal that organisations aim to achieve in their efforts to ensure that they are aware of and take steps to comply with relevant laws, policies, and regulations.

Compliance is an ongoing concern for organisations that partake in collaborations particularly in respect to how they collect, utilise and share collaboration data. For example, privacy concerns exist wherever personally identifiable information or other sensitive information is collected, stored, used, and finally destroyed or deleted. While not limited to collaborations, the problem with privacy and compliance with rules in general are exacerbated by the collection of data by different organisations which may have different standards of data collection, compliance rules or views on privacy. Improper or non-existent disclosure control within these organisations can be the root cause for compliance problems and, in particular, privacy issues. This problem becomes even more complicated when entities operate across different jurisdictions, which makes it difficult to comply with different rules from the different jurisdictions at the same time.

The present challenge is to build systems that can utilise collaboration data while protecting such things as an individual's privacy preferences and their personally identifiable information. Further, many systems that store sensitive data are susceptible to individuals such as administrators who have full system access. If the administrator goes “rogue” or an attacker gains access as an administrator the privacy of the data can be compromised.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

There is provided a system for managing access to compliant collaboration data comprising: a collaboration data store to store collaboration data that is encrypted with a collaboration master key associated with a collaboration between one or more organisations, wherein the collaboration master key is shared by the one or more organisations associated with the collaboration; a key store to store the collaboration master key associated with the collaboration; and a governance module adapted to determine the collaboration data is compliant with a set of compliance rules and based on the determination selectively cause access to be granted to the collaboration master key, wherein access by the same entity is prevented to two or more of the collaboration data store, key store and governance module.

The system may further comprise a processing module that is adapted to perform cryptographic operations on the collaboration data in the collaboration data store with the collaboration master key,

Preferably the processing module, collaboration data store, governance module and the key store are protected such that an entity has mutually exclusive access to either the processing module, key store, the governance module or collaboration data store,

Preferably the processing module is independent from the collaboration data store, governance module and key store.

Preferably the processing module is hosted in a separate instance from instances for the collaboration data store, governance module and key store.

Preferably the processing module is hosted on a server separate from servers for the collaboration data store, governance module and key store.

Preferably the organisation is associated with an organisation data key that is protected from access by other organisations.

Preferably the governance module is further adapted to receive a request for the organisation data key associated with one organisation of the one or more organisations and to determine if the one organisation is compliant with the set of compliance rules.

Preferably causing access to be granted comprises requesting and validating a passphrase.

Preferably the key store is adapted to: receive a request for the collaboration master key associated with an organisation; send a request for the collaboration passphrase to the organisation associated with the request; receiving a reply passphrase from the organisation; validate the reply passphrase against the one of the multiple collaboration passphrases associated with the requested collaboration master key, upon successfully validating the reply passphrase send the collaboration master key to the collaboration data store to allow decryption of the collaboration data with the collaboration master key.

There is also provide a method for requesting compliant collaboration data comprising: requesting, by a first organisation, a collaboration with a second organisation; selecting a subset of data from the collaboration to publish; requesting data encrypted with a collaboration master key; requesting the collaboration master key from a key store; validating the request based on a response from the first organisation; decrypting the data with the collaboration master key if the request is validated; and sending the unencrypted data to the first organisation.

There is also provided a method for publishing compliant collaboration data comprising: requesting, by a first organisation, a collaboration with a second organisation; selecting a subset of data from the collaboration to publish; requesting the subset of data encrypted with a collaboration master key; requesting the collaboration master key from a key store; validating the request based on a response from the first organisation; decrypting the data with the collaboration master key if the request is validated; and publishing the unencrypted subset of data.

There is also provided a method of managing compliant collaboration data comprising: storing collaboration data in a collaboration data store that is encrypted with a collaboration master key associated with a collaboration between one or more organisations, wherein the collaboration master key is shared by the one or more organisations associated with the collaboration; storing the collaboration master key associated with the collaboration in a key store; and determining, by a governance module, the collaboration data is compliant with a set of compliance rules and based on the determination selectively cause access to be granted to the collaboration master key, wherein access by the same entity is prevented to two or more of the collaboration data store, key store and governance module.

There is provided software, being machine readable instructions, that when performed by a computer system causes the computer system to perform the method described above.

### BRIEF DESCRIPTION OF DRAWINGS

Examples of the present disclosure will be described with reference to:

FIG. 1 illustrates an example system for managing access to collaboration data.

FIG. 2 illustrates a preferred configuration of an example system for managing access to collaboration data.

FIG. 3 illustrates a data upload by a non-compliant organisation.

FIG. 4 illustrates a data upload by compliant organisation.

FIG. 5 illustrates an encrypted data upload by a non-compliant organisation.

FIG. 6 illustrates an encrypted data upload by a compliant organisation.

FIG. 7a illustrates a data compliant request on compliant data.

FIG. 7b illustrates a data compliant request on non-compliant data.

FIG. 8a and FIG. 8b illustrates publishing data with compliant organisation, data and collaboration.

FIG. 9 illustrates requesting to publish non-compliant data.

FIG. 10 illustrates requesting to publish compliant data by a non-compliant organisation.

FIG. 11 illustrates requesting to publish compliant data by a compliant organisation from a non-compliant collaboration.

FIG. 12 illustrates retrieving data from a compliant collaboration.

FIG. 13 illustrates retrieving data from a non-compliant collaboration.

FIG. 14 illustrates a method for managing access to compliant collaboration data.

FIG. 15 illustrates an example system.

### DESCRIPTION OF EMBODIMENTS

The current disclosure related to a method and system for managing access to compliant collaboration data.

FIG. 1 illustrates an example computer system 100 for managing access to compliant collaboration data. The computer system comprises multiple modules: a collaboration data store 106, a key store 110 and a governance module 120. Each of these modules are described below.

### Collaboration Data Store

Collaboration data store 106 is a data store that is used to store collaboration data. This collaboration data is encrypted with a collaboration master key. In the example of FIG. 1 the collaboration database stores the collaboration data and the governance module 120 will request, receive and examine the collaboration data.

Collaboration data is associated with collaborations 152,154. In this example, the collaboration 152 is between Organisation A 142 and Organisation B 144. The collaboration 154 is between Organisation A 142 and Organisation C 146.

In the example of FIG. 1, the collaboration data store 106 contains a collaboration database 109, which is separated from the key store database 112.

The collaboration data store 106 may reside on an application 102. The application 102 in the example of FIG. 1 is the program that contains the logic for communicating the data within the system 100.

### Key Store

The key store 110 is a data store that is used to store the collaboration master key. In practice, the key store 110 is a store for all keys relating to organisations and collaborations. In other examples, there may be multiple key stores that together hold all keys relating to organisations and collaborations or there may be one key store to store the keys relating to organisations and another key store to store keys relating to collaborations.

In this example, each collaboration 152, 154 is associated with a different collaboration master key. One organisation 142 may have multiple collaborations 152,154 with different collaboration master keys so a collaboration between organisation 142 and organisation 144 will have a different collaboration master key between organisation 142 and organisation 146.

### Governance Module

The governance module 120 is adapted to determine the collaboration data is compliant with a set of compliance rules. The governance module makes this determination by examining the collaboration data, and based on the determination selectively causes access to be granted to the collaboration master key. In other words, the governance module 120 directs the key store 110 to allow access to the collaboration master key to either organisation only if the collaboration is compliant. Allowing access to a key may comprise sending the key to the requesting module or allowing the requesting module to use the key for decryption.

If the collaboration data is to be encrypted, the governance module may encrypt the collaboration data itself using the collaboration master key. Alternatively the encryption may be performed by another module such as the processing module (described below). In this case, the governance module will act as a gatekeeper and allow access to collaboration master key by the processing module only if the collaboration data is compliant with the compliance rules. If the collaboration data is not compliant then the organisation will not be able to enter the collaboration.

Each of the above modules are in communication with each other. They may be independently operating instances or computers, virtual machines, networked computers or cloud instances. The communication between modules may be any form or wired or unwired connection. If it is using cellular, preferably the cellular connection is 4G due to the extra capacity for communicating data, but the system may also work with other data communication technologies such as 2G and 3G. Where available, the system may also be able to utilise a Wi-Fi or other wireless data connection.

By separating the modules, there is a reduced risk of the encryption keys or organisation or collaboration data being compromised. Further access by the same entity, such as an organisation or administrator of a system, is prevented to two or more of the collaboration data store, key store and governance module.

The keys, data and encryption processes can therefore be separated to reduce risk of a single person, such as a “rogue” employee having enough access permission and opportunity to compromise the system. This is also beneficial where the system is compromised by an attacker. The modular nature of the system means that a component may be compromised without necessarily affecting other components. Further this adds an extra layer of security which can be beneficial given the system's focus on compliance and particularly privacy concerns.

### System

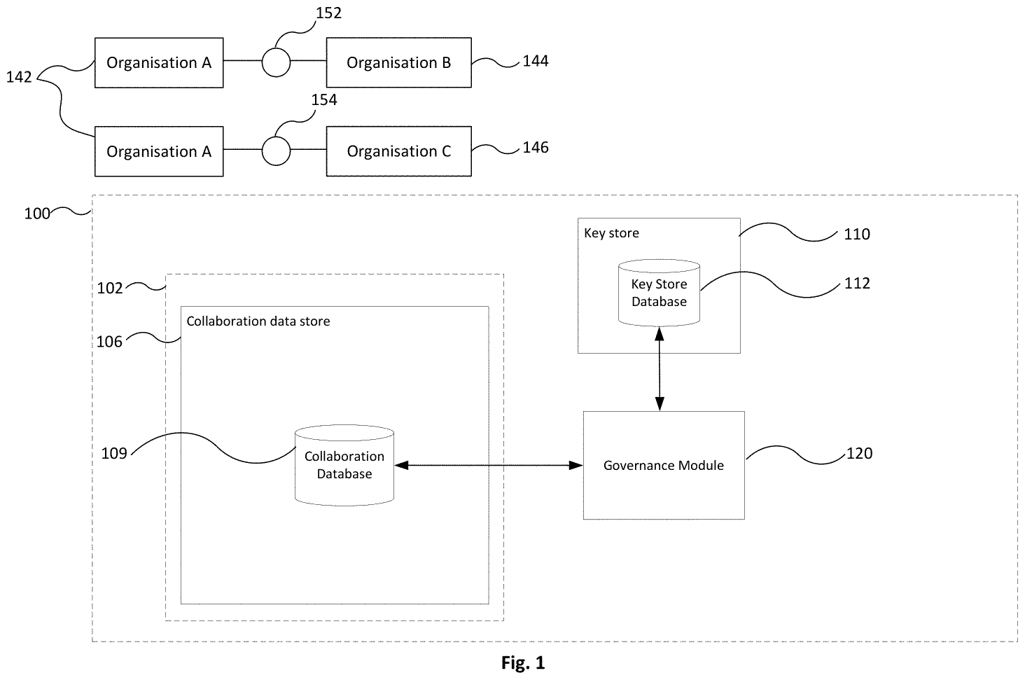

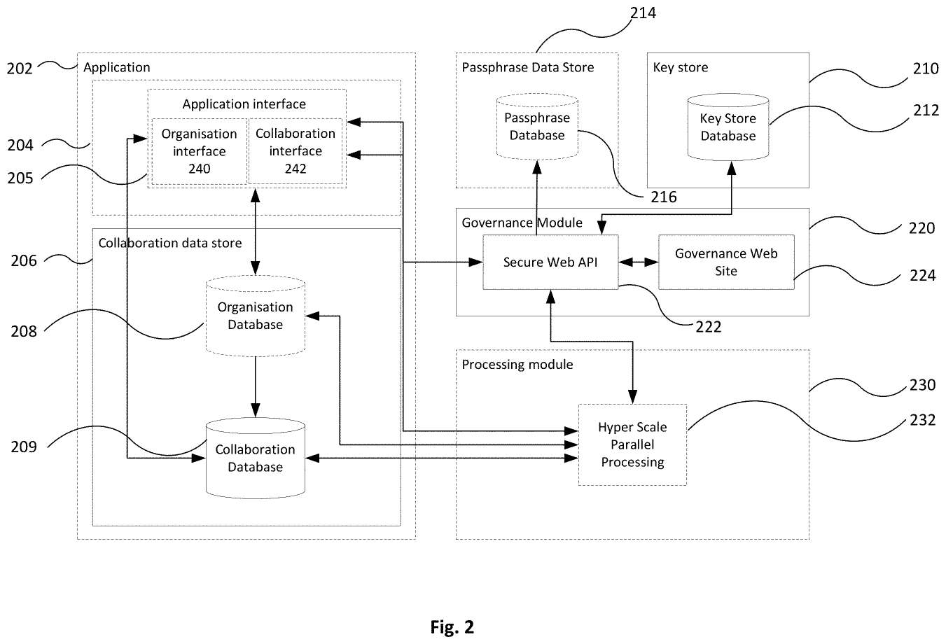

FIG. 2 illustrates how the system might be implemented in practice. As can be seen there are a number of additional elements to the system: including a processing module 230, an organisation database 208, and a passphrase data store 214. Further the preferred embodiment includes an application 202.

### Processing Module

A processing module 230 is a module that is adapted to perform cryptographic operations on the collaboration data in the collaboration data store with the collaboration master key. Cryptographic operations include encryption and decryption. In FIG. 2, the processing module 230 contains a processing service 232 that operates to perform the processing of cryptographic operations in hyper scale parallel processing. On this basis the processing module may receive encrypted organisation data which can be decrypted with the organisation's key and then re-encrypted with the a collaboration master key and it may do this processing for many organisations at once in parallel.

The processing module 230 is preferably hosted on separate servers to the rest of the platform and in a different cloud instance. Although the processing module 230 is shown as an independent network element in FIG. 2, the processing module 120 may also be part of another network element. Further, functions performed by the processing module 120 may be distributed between multiple network elements in FIG. 2.

Given that collaboration data can be very sensitive a processing module that performs only cryptographic operations enables it to operate independently of the other modules. Similarly to the benefit from the system configuration described above, by separating the processing module from other modules, this allows for a system configuration where a person such as a system administrator would not be able to access the collaboration data store, key store and governance module.

### Organisation Data Store

The organisation database 208 is a data store that stores data related to an organisation. The data that is stored in the organisation data store can be encrypted with a key that is specific to the organisation. While the data that the organisation requires to be stored can then be protected, the use of an organisation data key means that the data will need to be decrypted and re-encrypted with the collaboration master key once the organisation data is added to a collaboration.

The organisation data store 108 can be hosted on a database server with a platform cloud instance. It may be hosted on the same database server that the collaboration data store 106 is hosted on, but it can be hosted separately for additional security.

### Passphrase Data Store

The passphrase data store 214 is used to store the passphrases that are required for a key to be extracted from the key store. A passphrase is a sequence of words or other text that may be used to control access to one or more components of the system. A passphrase is similar to a password in usage, but is generally longer for added security. Passwords are typically less safe to use as keys for security systems such as those in this system that expose data to enable offline password guessing by an attacker. In this example, the passphrase data store 214 contains the passphrase database 216 which stores the passphrases separately from the keys in the key store database 212.

In another example the passphrases is not stored within the data governance module. In this case, each time the passphrase is entered it is converted to an encryption key, this key is then used to secure access to collaborator specific keys (within the collaborator and within the collaboration). Therefore, it is not necessary to send the passphrase to the data governance module for “verification” as there is nothing to be compared against. The data governance module could still receive the passphrase and generate the encryption key, maintaining passphrase handling separate from the main platform. If the incorrect phrase is entered, a key is still generated but the generated encryption key will not be able to decrypt the encrypted data and is therefore unable to provide access.

### Application

The application 202 contains the code and logic of interacting with the system 100. The application 202 preferably contains an application module 204 with an application interface 205 which comprises an organisation interface 240 and a collaboration interface 242. The organisation interface 240 is the interface that is specific to an organisation such as 142, 144 or 146, whereas the collaboration interface 242 is the interface that is specific to a collaboration such as 152 or 154. Application 202 may be installed and executed in binary form at an organisation or on a computer or server controlled by the organisation. In other examples, application 202 is a web-application that can be accessed by the organisation over the internet and is password protected to prevent others than the organisation from accessing the data.

### Governance Module

In a preferred embodiment, the governance module may be comprised of a secure web application programmable interface (API) 222 and a governance web site 224. The secure web API may be used such that all key requests go through this API ensuring that compliance and security processes are adhered to before returning the key. The governance web site 224 may be used to assess compliance and manage key security.

### Compliance Rules

Compliance rules can be any rules about the data that can be validated by examining the data itself. Compliance rules are often privacy related, such as for example, ensuring data does not reveal identifying personal information. For the case of a demographic analysis of house purchasers, the individual names and addresses may be removed from the data to make the system compliant with the set of compliance rules. In this collaboration data the suburb and age range may be maintained in the data. As a result, the demographic analysis can still be performed without the personal identifying information.

Compliance rules may be rules about the content of the data but may also be rules about the form of the data or the type of the data. Compliance rules type checking for example would cover the data being uploaded into the wrong column, for example, column heading is “State” but the data in the column is “Person Name”. That is, the compliance rules check that the data is type of state, which may be straightforward to check because the states in a geographical area would be finite and unlikely to conflict. There may be a small number of exceptions, for example the names Georgia and Virginia and the corresponding states of the United States. Even in this situation a person is likely to have a last name where a ‘State’ does not and therefore this distinguishes the ‘Person Name’ data from the ‘State’ data and this can be built into the compliance rules.

### Sharing Collaboration Data—Overview Example

In practice, not all data can be shared between organisations freely. Data acquired by one organisation is often subject to restrictions as to how the data may be shared. One typical example of a restriction is privacy where an individual may have consented to reveal their identity for one purpose, such as their personal details for purchasing a house, and another organisation wishes to utilise that data for another purpose such as data analytics for the demographics of home ownership.

Compliance rules may be for example, not revealing identifying personal information. For the case of a demographic analysis of house purchasers, the individual names and addresses may be removed from the data to make the system compliant with the set of compliance rules. In this collaboration data the suburb and age range may be maintained in the data. As a result, the demographic analysis can still be performed without the personal identifying information.

Given the identifying personal information has been stripped from the collaboration data, the governance module causes access to be granted to the collaboration master key for the organisation that is sharing the collaboration data. That is, the governance module determines that the collaboration data is compliant and therefore can be encrypted with the collaboration master key. If the governance module determines that the collaboration is not compliant then the governance module will determine that the organisation will not be able to get access to the collaboration master key and will have to make changes to the collaboration data in order for it to be shared with another organisation.

In some cases, the compliance rules may be checked as and flagged as warnings rather than strict restrictions. In this case, the compliance rules do not need to be strictly complied with in the sense of restricting any further access but may be indicated as problematic. For example, data that contains information that reveals an unnamed person of a given age in a specified suburb may not be identifying information in itself, but an unnamed person of a given age, religion, racial background and purchasing habits may be identifying in combination.

### DETAILED EXAMPLES

### Data Upload (Non Compliant Organisation)

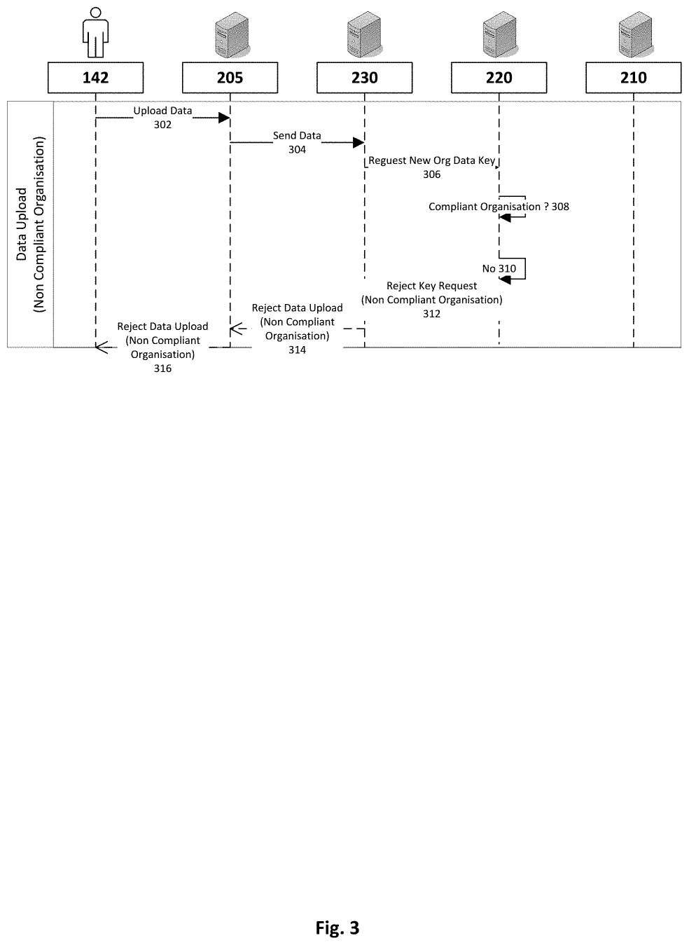

The scenario depicted in FIG. 3 covers the example where a non-compliant organisation 142 is attempting to upload data 302 into the platform. In this scenario, data is uploaded 304 to the platform and encryption is attempted. When a key is requested from the data governance service 220 a compliance request is made. In this scenario the organisation 142 is determined to be not compliant and the key request is rejected 312 which results in the data upload 314, 316 being rejected.

### Data Upload (Compliant Organisation)

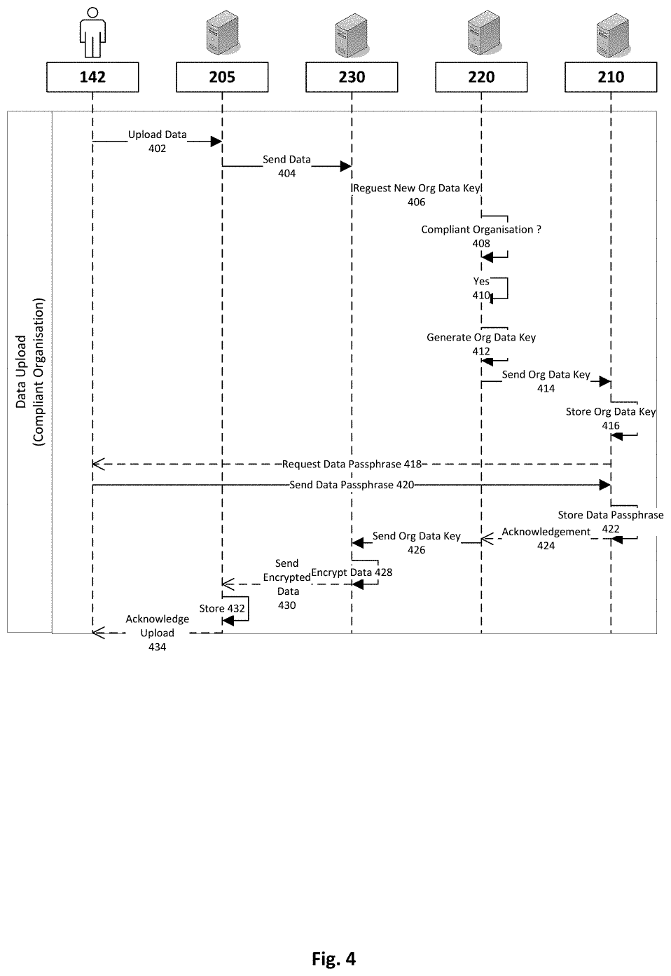

In the scenario in FIG. 4 a compliant organisation uploads 402 data to the platform. Data is sent 230 to processing module for encryption and a new encryption key is requested 406 from the governance module 220. The organisation is assessed 408, which in this case is determined 410 to be compliant, a new encryption key is generated 412 and sent 414 to the key store 210 which stores 416 the key. The key store 210 then requests 418 a passphrase from the organisation 142 which is stored 420 alongside the encryption key and used to validate all future requests for the key. Importantly the passphrase request and response go directly to the organisation user and not though any other modules, reducing opportunity to compromise the key. Once received an acknowledgement is sent 424 to governance module 220 enabling the release of the encryption key to be sent 426 to the processing module 230. The uploaded data is encrypted 428, sent to application interface 205 and stored 432 and acknowledgement sent 434 back to the organisation 142.

### Encrypted Data Upload (Non-Compliant Organisation)

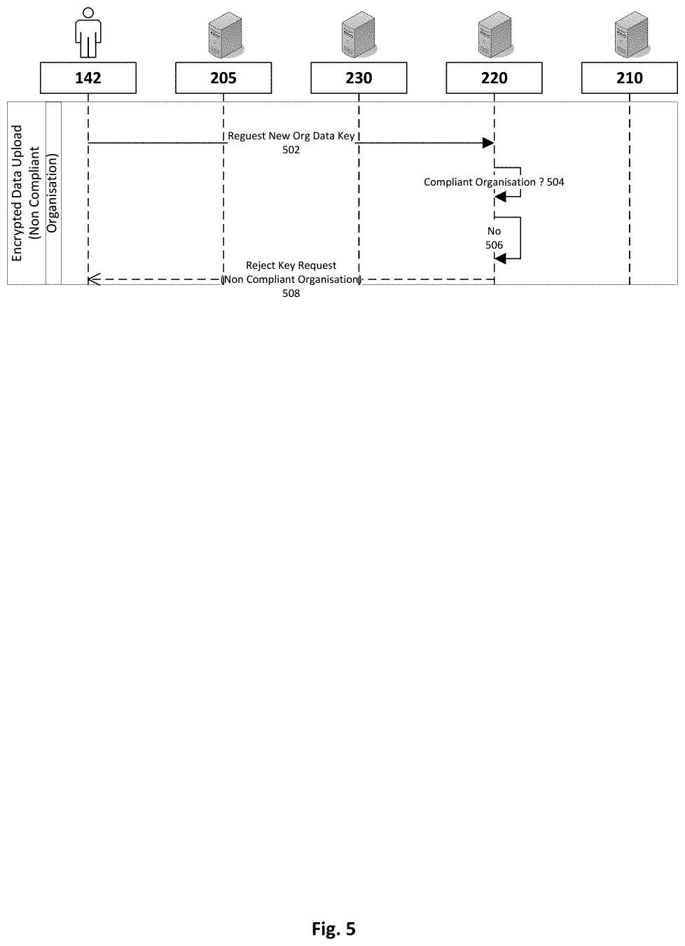

In the scenario in FIG. 5 the organisation 142 would like to encrypt the data before uploading to the platform 100. At the start of the upload process a request is sent to the data governance service 220. This request does not go via any other areas of the platform where the key could be compromised. The data governance service 220 requests a compliance check 508 on the organisation prior to issuing the key, which fails. The key request is rejected and the upload of data does not proceed.

### Encrypted Data Upload (Compliant Organisation)

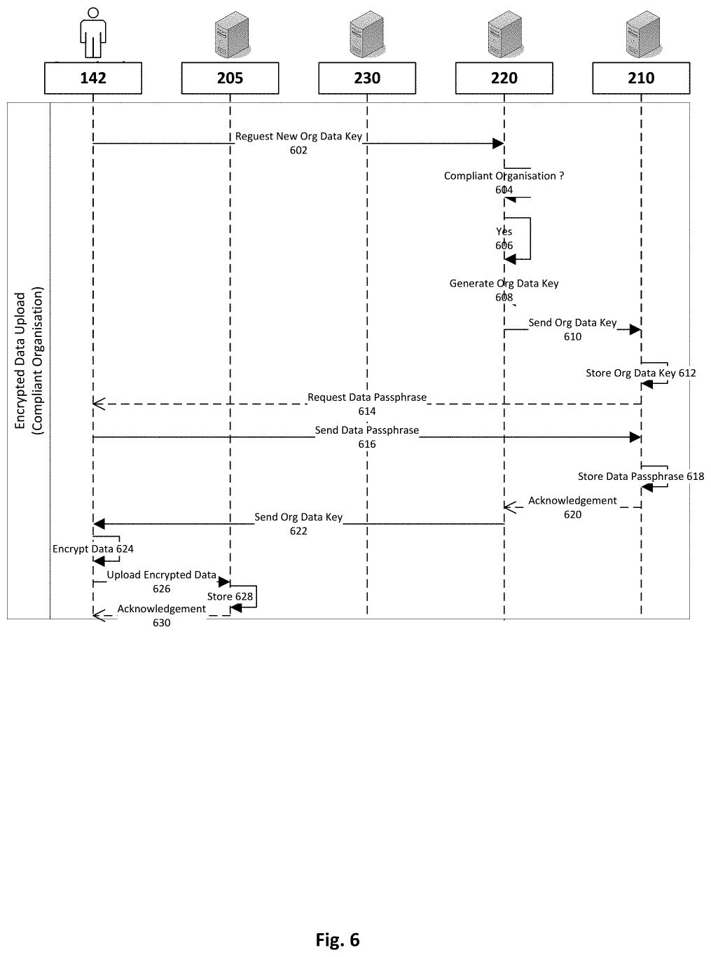

In the scenario in FIG. 6, uploading encrypted data for a compliant organisation follows similar set of steps to the scenario above but in a different order. In this scenario, the organisation 142 requests 602 a new organisation data key from the governance module 220. The governance module then determines 604 if the organisation is compliant according to a set of compliance rules.

In this example, the organisation is determined to be compliant 606 and the process continues. The governance module 220 generates the organisation data key 608 and sends 610 the organisation data key to the key store 210. The key store 210 then stores 612 the organisation data key. In this example the key store requests 614 a data passphrase from the organisation 142 and the organisation sends 616 the data passphrase in response. The data passphrase is stored 618 in the key store 210 and the key store sends 620 an acknowledgement to the governance module 220. The governance module 620 then sends 622 the organisation data key to the organisation 142 which the organisation can use to encrypt data. In this example, the organisation 142 then encrypts the data 624 and uploads 624 the encrypted data via the application interface module 202. The application interface module 202 then stores the encrypted data

### Data Compliance Check

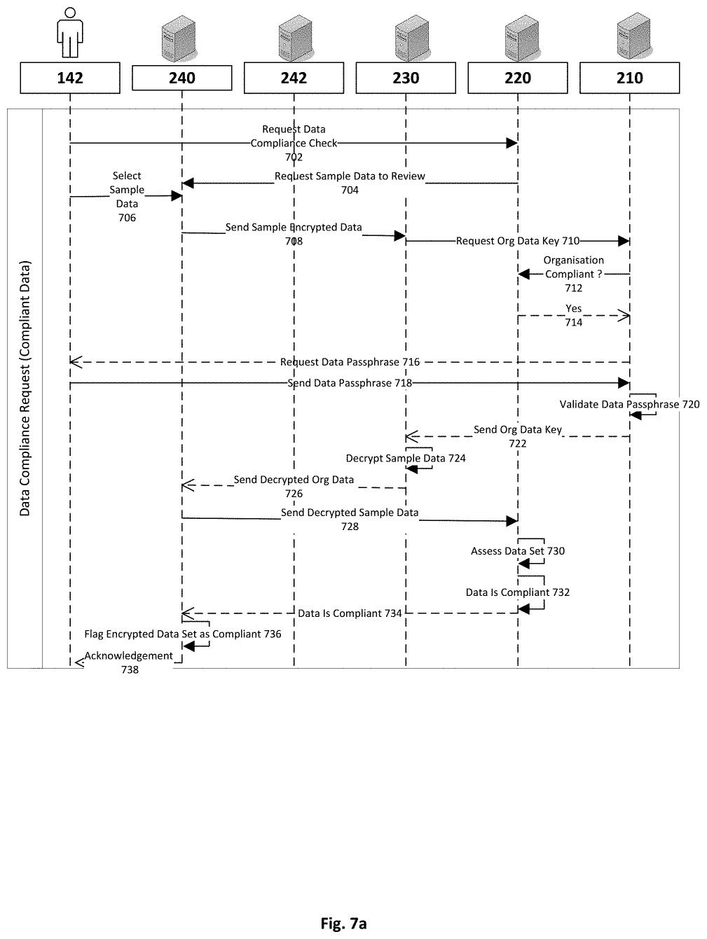

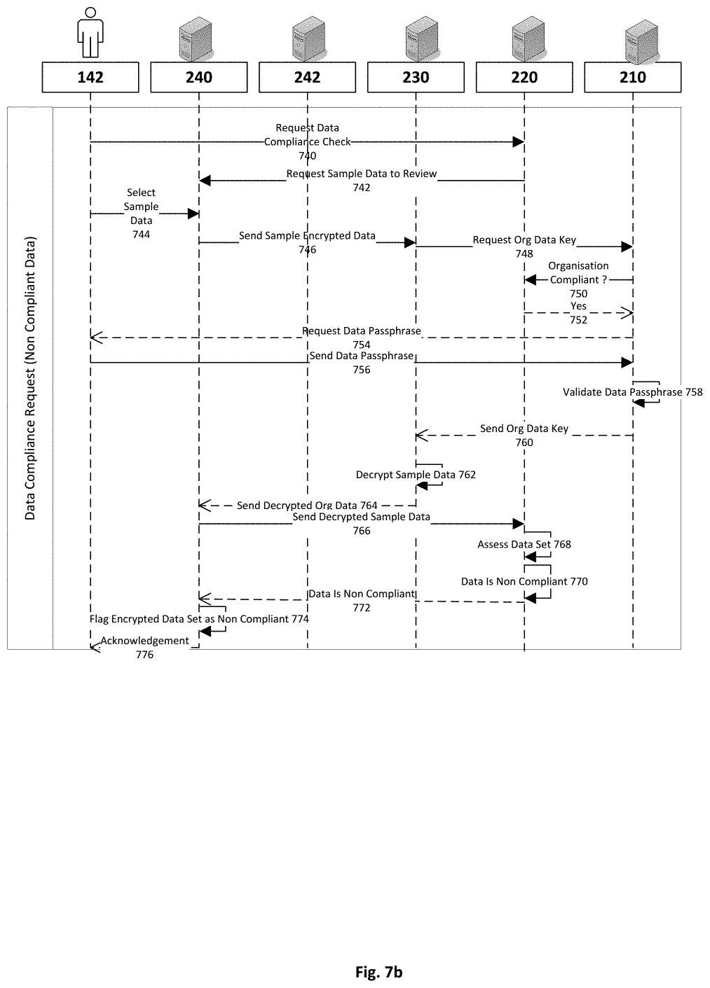

In the scenario in FIG. 7a and FIG. 7b, a data compliance check is required with the framework to ensure that the data upload by the organisation does not breach any compliance rules.

In the example of FIG. 7a, the organisation 142 initiates 702 a review of any uploaded data sets that require compliance. The governance module 220 then requests 704 a set of sample data to review to assess compliance. Examples of sample data selection could be: a limited number of complete records, the whole set, random cells in each column with no cells from the same record. The users of the organisation select 706 a sample set of data that will enable the compliance assessment. The application interface module 202 then sends 708 the sample encrypted data to the processing module 230 for decryption. Note that the selection of the data to be assessed as well as the key and passphrase requests all remain within the organisation 142. Therefore, the governance module 220 (or governance assessor) does not require access to the organisation, its data, keys or passphrases. In another example, random samples of the data are exposed to the compliance checker to identify data under incorrect field names or other issues. The compliance checker may be human or an algorithm that matches the data samples against known patterns.

The standard key and passphrase process 710 to 724 then takes place to decrypt the selected data. The decrypted data is sent back 726 to the organisation for review before sending 728 to the governance module 220. Once the governance module 220 receives the sample data it can be assessed 730 for compliance and the result sent back to the organisation and the data flagged as compliant or not. In this example governance module 220 assesses 732 the data as compliant. The application interface 202 is informed the data is compliant by the governance module 220. The application interface 202 then flags 736 the encrypted data as compliant and sends 738 an acknowledgement to the organisation 142.

In the example of FIG. 7b, the organisation similarly to the above 142 initiates 740 a review of any uploaded data sets that require compliance. The governance module 220 then requests 742 a set of sample data to review to assess compliance. The users of the organisation select 744 a sample set of data that will enable the compliance assessment. The application interface module 202 then sends 748 the sample encrypted data to the processing module 230 for decryption.

The standard key and passphrase process 748 to 762 then takes place to decrypt the selected data. The decrypted data is sent back 764 to the organisation for review before sending 766 to the governance module 220. Once the governance module 220 receives the sample data it can be assessed 730 for compliance and the result sent back to the organisation and the data flagged as compliant or not. In this example governance module 220 assesses 768 the data as non-compliant. The application interface 202 is informed the data is non-compliant by the governance module 220. The application interface 202 then flags 774 the encrypted data as non-compliant and sends 776 an acknowledgement to the organisation 142.

It is preferable in some embodiments that any changes to the data set after a compliance assessment has been made will cause the compliance flag be set to “assessment required”.

### Publishing Data

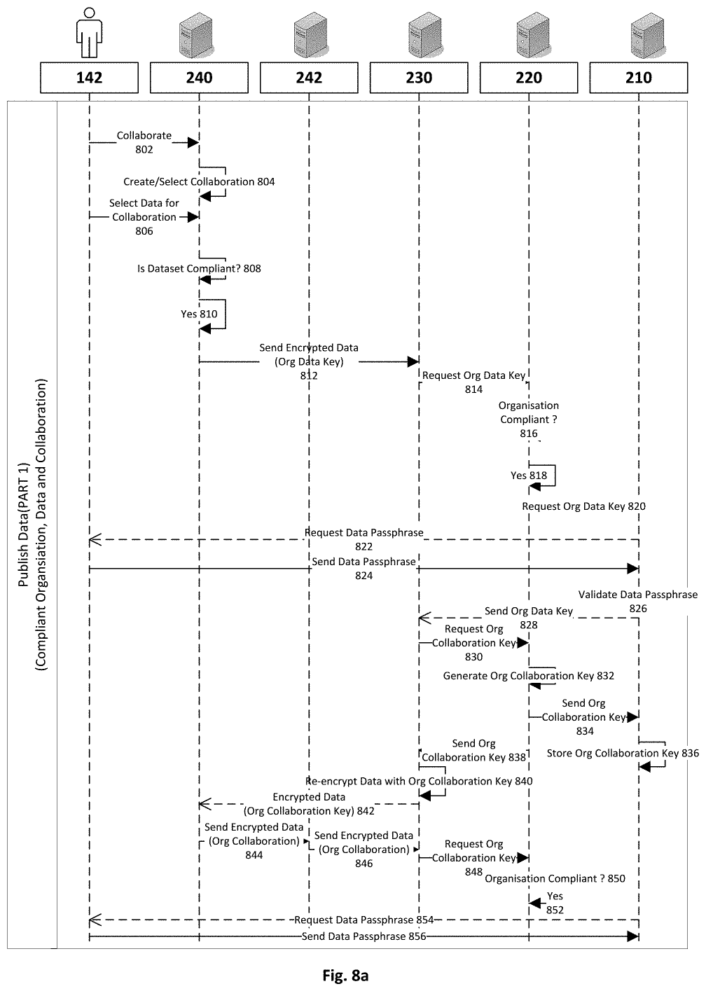

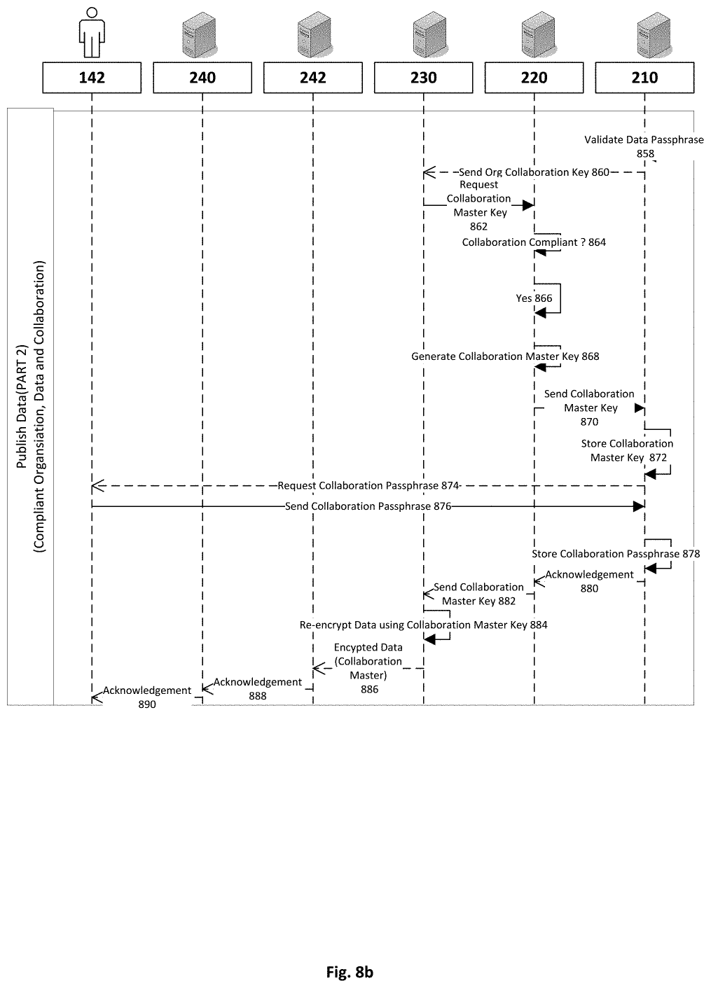

In the scenario depicted in FIG. 8a, an organisation 142 enters 802 into a collaboration 152 with organisation 144. The organisation 142 selects 804 the collaboration to be a participant and selects 806 the data to publish into the collaboration 152. At this point the data set is checked 808 to determine if it is compliant. The process to determine if a data set is compliant is executed prior to publishing data into a collaboration and marks the data set as compliant or not. In this example the dataset is determined to be compliant 810 and the process continues.

Given the data is compliant the encrypted data is sent 812 to the processing module for re-encryption before it is sent to the collaboration. Re-encryption is performed because the encryption process and keys used within the organisation are not the same as the ones used within the collaboration. In order to decrypt the data, the processing module first requests 814 the organisation data key from via the governance module 220. At this point, a similar process 816 to 828 is followed as outlined in the earlier steps, i.e. a compliance check against the organisation and a request for the pass phrase to authenticate the identity of the entity requesting the key.

Once the data has been decrypted a request 830 is made for a new key specific to the combination of organisation 142 and collaboration 152. The governance module 220 generates 832 the organisation collaboration key and sends 834 the key to the key store 210 to store it. The governance module also sends 838 the organisation collaboration key to the processing module 838. The data is encrypted 840 with the organisation collaboration key and sent 842 back to the application interface 202. The data is now ready to be sent to the collaboration 152.

The application interface 240 sends the encrypted data to the collaboration 152 via the collaboration interface 242. When the encrypted data is received in the collaboration it is re-encrypted using the mechanism used for collaboration so the collaboration interface 242 sends 846 the data to the processing module to decrypt and re-encrypt the data.

A similar mechanism as above is used to retrieve the organisation collaboration key to decrypt the data (steps 848 to 860). A master collaboration key is then requested 862 which is specific to the collaboration 152.

This key is used to encrypt the data and then place it to the collaboration—each data set from all collaborators in the collaboration uses this master collaboration key. In this scenario the governance module 220 determines if the collaboration is compliant 864, and in this example the collaboration is compliant 866. The collaboration master key 868 is then generated 868 and sent 870 to the key store 210. The collaboration master key 872 is then stored 872 in the key store 210.

In the preferred configuration of the system, the master collaboration key is not exposed to the collaborators and is only supplied to the processing module 230. In this example the collaboration passphrase (different to the organisation data passphrase) is used to ensure that key requests related to the data in a collaboration can only be performed by authorised users. The key store 210 requests 874 the organisation 142 provide the collaboration passphrase. The collaboration passphrase 876 is then sent 876 to the key store 210, and the key store 210 stores 878 the collaboration passphrase. The key store 210 then sends 880 an acknowledgement to the governance module 220 and the governance module 220 then sends 882 the collaboration master key 832 to the processing module 230. The processing module 230 then re-encrypts 884 the data with the collaboration master key, and sends 886 the encrypted data to the collaboration interface. The collaboration interface 242 then acknowledges 888 to the organisation interface 240 that the encrypted data is received, and the organisation interface 240 acknowledges 890 to the organisation that the collaboration interface 242 has received the encrypted data.

### Publish Data (Non-Compliant Data)

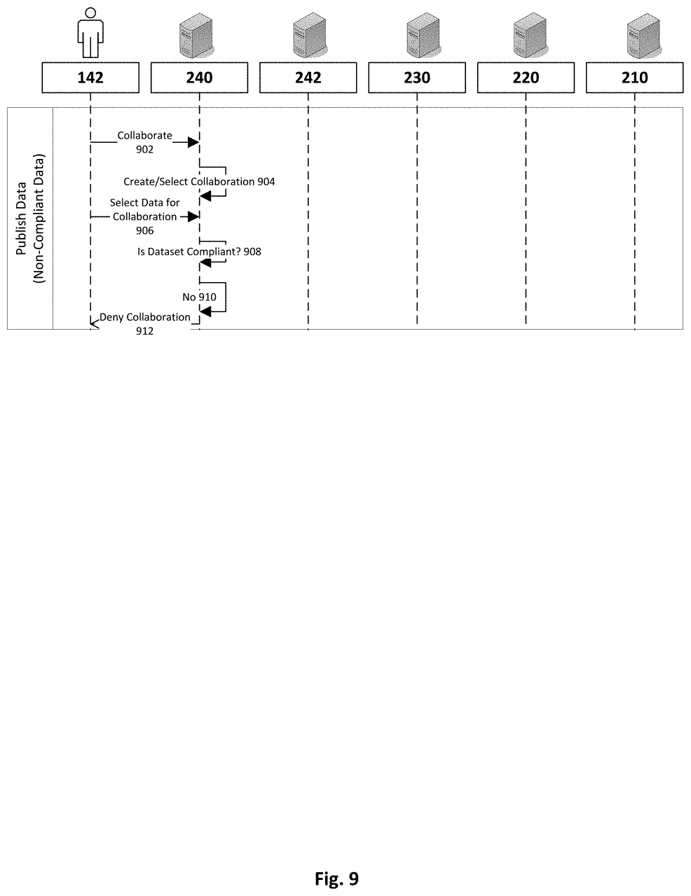

In the scenario illustrated in FIG. 9, the dataset is non-compliant. As can be seen, if the data set is not marked as compliant (see earlier sections regarding assessing data) then the attempt to push data into a collaboration is blocked immediately.

In this scenario an organisation enters into a collaboration 902, and creates or selects 904 a collaboration 152. The organisation 142 then selects 906 data for the collaboration. The organisation interface 240 then checks 908 if the dataset is compliant. In this example, the dataset is determined 910 to be not compliant. The collaboration is then denied 912 to the organisation 142.

### Publish Data (Non-Compliant Organisation)

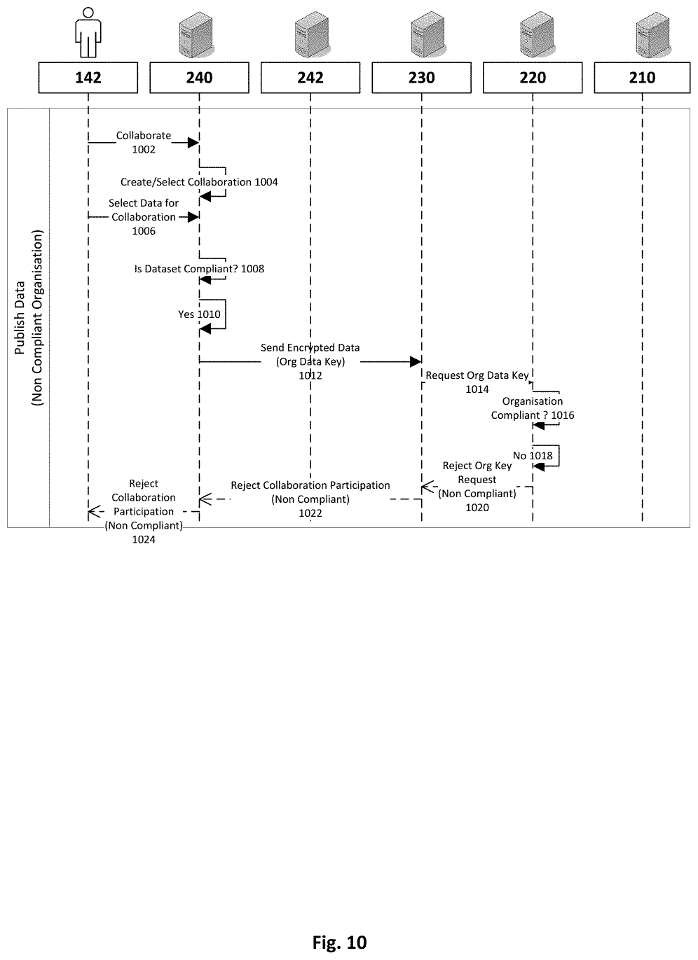

In the scenario in FIG. 10 the data set is compliant but the organisation is not. When the organisation attempts to retrieve the key to enable the organisation data to be decrypted the request is rejected and the data is unable to be sent to the collaboration.

In this scenario an organisation enters into a collaboration 1002, and creates or selects 1004 a collaboration 152. The organisation 142 then selects 1006 data for the collaboration. The organisation interface 240 then checks 1008 if the dataset is compliant. In this example, the dataset is determined 1010 to be compliant and the process continues.

The organisation interface 240 sends the data, encrypted with the organisation data key, to the processing module 230. The processing module 230 then requests 1014 the organisation data key from the governance module 220. The governance module 230 then determines 1016 if the organisation is compliant. In this example, the organisation is determined 1018 to be non-compliant and the request for the organisation data key is denied to the processing module 230. The processing module then rejects 1022 the collaboration participation to the organisation interface 240 and the organisation interface 240 informs the organisation 142 that the collaboration has been rejected.

### Publish Data (Non-Compliant Collaboration)

The final non-compliance scenario for collaborating is where the collaboration is not compliant. In this case the attempt to move data into the collaboration is blocked when the master collaboration key is requested. This is the key used to re-encrypt the data as it leaves the organisation and is moved into the collaboration.

In this scenario an organisation enters into a collaboration 1102, and creates or selects 1104 a collaboration 152. The organisation 142 then selects 1106 data for the collaboration. The organisation interface 240 then checks 1108 if the dataset is compliant. In this example, the dataset is determined 1110 to be compliant and the process continues.

The organisation interface 240 sends the data, encrypted with the organisation data key, to the processing module 230. The processing module 230 then requests 1014 the organisation data key from the governance module 220. The governance module 230 then determines 1016 if the organisation is compliant. In this example, the organisation is determined 1018 to be compliant and process continues.

A similar mechanism as above is used to retrieve the organisation data key and the organisation master key to decrypt the data.

In this scenario the governance module 220 determines if the collaboration is compliant 1146, and in this example the collaboration is non-compliant 1148. The governance module 220 rejects the request for the collaboration master key and informs 1150 the processing module 230. The processing module 230 then sends 1152 the rejection to the organisation interface 240, which then informs 1154 the organisation that the collaboration is rejected.

### Retrieving Data

When data is requested from the collaboration, a compliance check may be required when the collaboration key is requested. Once a compliance check has been completed, and passed, the collaboration key can be returned and the data decrypted.

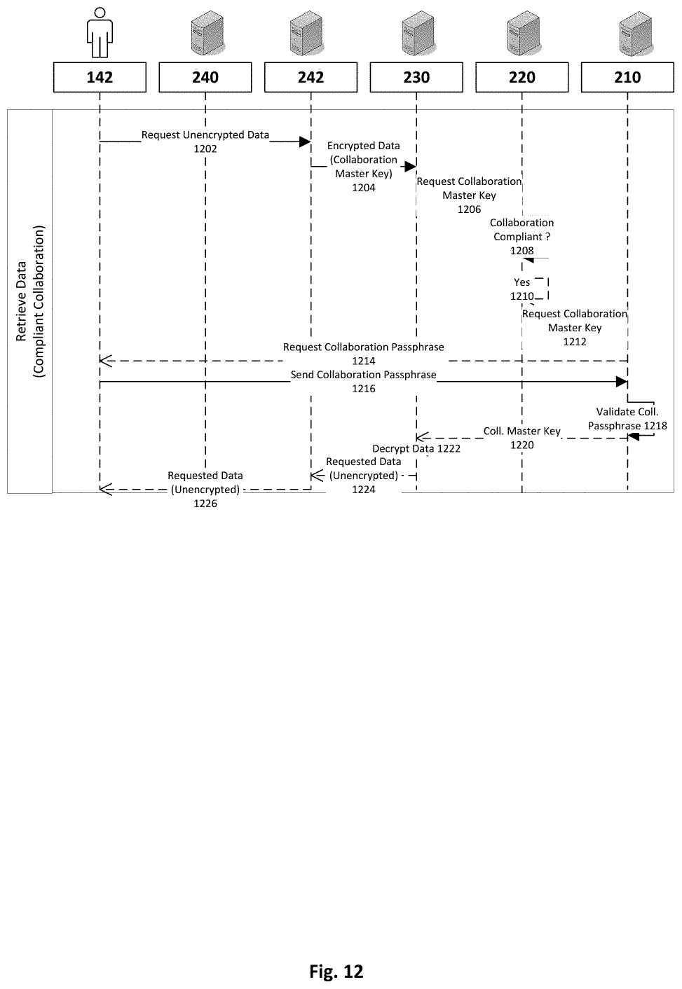

In the scenario in FIG. 12 the organisation 1202 requests unencrypted data from the collaboration interface 242. The collaboration interface 242 requests 1204 the encrypted data to be decrypted by the processing interface 230. The processing interface 530 requests 1206 the collaboration master key from the governance module 220. The governance module determines 1208 if the collaboration is compliant and in this case the collaboration is determined 1210 to be compliant. Similar steps to the above are performed to request the collaboration master key 1212 to 1220, and the processing module decrypts 1222 the data with the collaboration master key. The unencrypted data is then returned 1224 to the collaboration interface 242 and the collaboration interface 242 sends 1226 the requested data to the organisation 142.

### Retrieving Data (Non-Compliant Collaboration)

If the collaboration is not compliant the master collaboration key is not returned and the request for data from the collaboration is blocked.

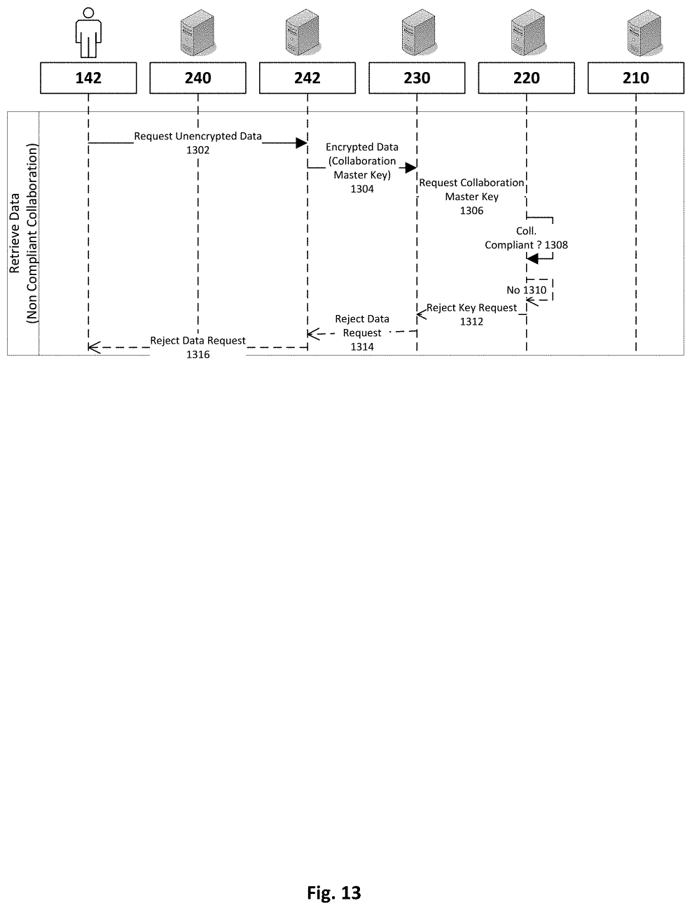

In the scenario in FIG. 13, the organisation 1302 requests unencrypted data from the collaboration interface 242. The collaboration interface 242 requests 1304 the encrypted data to be decrypted by the processing interface 230. The processing interface 530 requests 1306 the collaboration master key from the governance module 220. The governance module determines 1308 if the collaboration is compliant and in this case the collaboration is determined 1310 to be non-compliant. The governance module 220 rejects 1312 the key request from the processing module 230. The processing module 230 then rejects the decryption request from the collaboration interface 242 and the organisation 142 is then informed 1316 that the request for data from the collaboration is rejected.

### Example Method

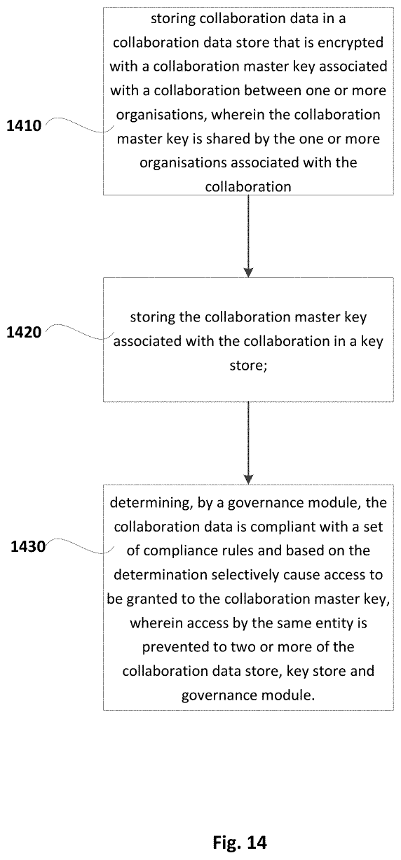

FIG. 14 illustrates a method for managing access to compliant collaboration data. The first step 1410 involves storing collaboration data in a collaboration data store that is encrypted with a collaboration master key associated with a collaboration between one or more organisations, wherein the collaboration master key is shared by the one or more organisations associated with the collaboration.

The second step 1420 involves storing the collaboration master key associated with the collaboration in a key store 110.

The third step 1430 involves determining, by a governance module 120, the collaboration data is compliant with a set of compliance rules and based on the determination selectively cause access to be granted to the collaboration master key, wherein access by the same entity is prevented to two or more of the collaboration data store, key store and governance module. The governance module may grant access to the collaboration master key, or alternatively another module or entity may grant access to the collaboration master key based on the determination made by the governance module.

### Example System

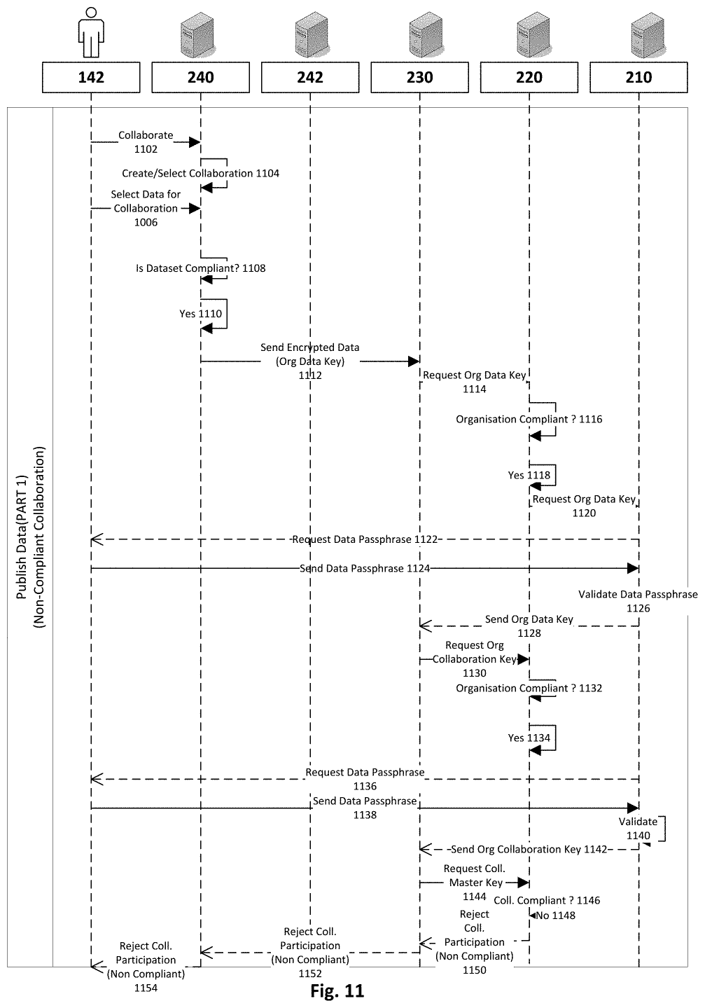

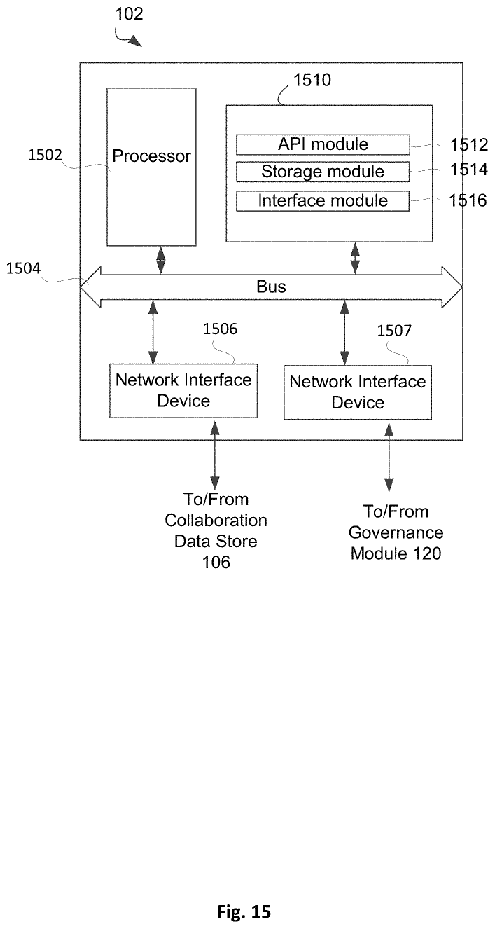

The system 102 shown in FIG. 15 includes a processor 1502, a memory 1510, a network interface devices 1506,1507 that communicate with each other via a bus 1504. The memory stores instructions 1512, 1514, and 1516 and data for the processes described with reference to FIGS. 1 to 14, and the processor performs the instructions from the memory to implement the processes.

The processor 1502 performs the instructions stored on memory 1510. Processor 1502 receives an input from an organisation 142,144,146. Processor 1502 determines an instruction according to the API module 1512. The instruction may be a function to execute according to the method to manage compliant collaboration data. The processor 3102 may execute instructions stored in the storage module 1514 to store the data associated with the collaboration 152,154. The processor 1502 may execute instructions stored in the interface module 1516 to communicate with the governance module 120.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A system for managing access to compliant collaboration data comprising:
a collaboration data store to store collaboration data that is encrypted with a collaboration master key associated with a collaboration between one or more organisations, wherein the collaboration master key is shared by the one or more organisations associated with the collaboration;
a key store to store the collaboration master key associated with the collaboration; and
a governance module adapted to determine the collaboration data is compliant with a set of compliance rules and based on the determination selectively cause access to be granted to the collaboration master key,
wherein access by the same entity is prevented to two or more of the collaboration data store, key store and governance module.

2. The system of claim 1 further comprising a processing module that is adapted to perform cryptographic operations on the collaboration data in the collaboration data store with the collaboration master key,

3. The system of claim 2 wherein the processing module, collaboration data store, governance module and the key store are protected such that an entity has mutually exclusive access to either the processing module, key store, the governance module or collaboration data store,

4. The system of claim 2 or 3 wherein the processing module is independent from the collaboration data store, governance module and key store.

5. The system of claim 2, 3 or 4 wherein the processing module is hosted in a separate instance from instances for the collaboration data store, governance module and key store.

6. The system of any of the preceding claims wherein the processing module is hosted on a server separate from servers for the collaboration data store, governance module and key store.

7. The system of any of the preceding claims wherein the organisation is associated with an organisation data key that is protected from access by other organisations.

8. The system of any of the preceding claims wherein the governance module is further adapted to receive a request for the organisation data key associated with one organisation of the one or more organisations and to determine if the one organisation is compliant with the set of compliance rules.

9. The system of any of the preceding claims wherein causing access to be granted comprises requesting and validating a passphrase.

10. The system of claim 8 wherein the key store is adapted to:
receive a request for the collaboration master key associated with an organisation;
send a request for the collaboration passphrase to the organisation associated with the request;
receiving a reply passphrase from the organisation;
validate the reply passphrase against the one of the multiple collaboration passphrases associated with the requested collaboration master key,
upon successfully validating the reply passphrase send the collaboration master key to the collaboration data store to allow decryption of the collaboration data with the collaboration master key.

11. A method for requesting compliant collaboration data comprising:
requesting, by a first organisation, a collaboration with a second organisation;
selecting a subset of data from the collaboration to publish;
requesting data encrypted with a collaboration master key;
requesting the collaboration master key from a key store;
validating the request based on a response from the first organisation;
decrypting the data with the collaboration master key if the request is validated; and
sending the unencrypted data to the first organisation.

12. A method for publishing compliant collaboration data comprising:
requesting, by a first organisation, a collaboration with a second organisation;
selecting a subset of data from the collaboration to publish;
requesting the subset of data encrypted with a collaboration master key;
requesting the collaboration master key from a key store;
validating the request based on a response from the first organisation;
decrypting the data with the collaboration master key if the request is validated; and
publishing the unencrypted subset of data.

13. A method of managing compliant collaboration data comprising:
storing collaboration data in a collaboration data store that is encrypted with a collaboration master key associated with a collaboration between one or more organisations, wherein the collaboration master key is shared by the one or more organisations associated with the collaboration;
storing the collaboration master key associated with the collaboration in a key store; and
determining, by a governance module, the collaboration data is compliant with a set of compliance rules and based on the determination selectively cause access to be granted to the collaboration master key,
wherein access by the same entity is prevented to two or more of the collaboration data store, key store and governance module.

14. Software, being machine readable instructions, that when performed by a computer system causes the computer system to perform the method of claim 11, 12 or 13.
